(19) United States
(12) Patent Application Publication
(10) Pub. No.: US 2006/0231039 A1
(43) Pub. Date: Oct. 19, 2006

(54) Restricted access food dish for animals

(76) Inventors: Sharon M. Abinanti, Palatine, IL (US); T. Michael Abinanti, Palatine, IL (US)

Correspondence Address: Douglas H. Pauley;Pauley Petersen & Erickson, Suite 365, 2800 West Higgins Road, Hoffman Estates, IL, 60195, US

(21) Appl. No.: 11/106,842

(22) Filed: Apr. 15, 2005

(51) Int. Cl. A01K 5/01

(52) U.S. Cl. 119/61.56

(57) ABSTRACT

An animal feeding dish having a main receptacle with a volume for holding food and a body tenaciously attached within, or formed integrally within, the volume of the main receptacle limits the feeding rate of a ravenous animal to prevent negative consequences of high rate devouring of food placed within the dish.

### BACKGROUND OF THE INVENTION

1. Field of the Invention

The present invention generally relates to animal feeding dishes, troughs, or the like, hereinafter collectively referred to as dishes. The present invention relates specifically to feeding dishes which slow the rate of animal feeding.

2. Discussion of Related Art

Certain animals may be gluttonous or ravenous feeders to the extent that they may harm themselves. In domesticated animals this is a common problem for mammals such as horses and dogs. When the animal eats too much, or too fast, or both, there may occur unpleasant, unhealthy, or even life-threatening conditions, including vomiting, abdominal distress, colic, intestinal torsions, or the like.

### SUMMARY OF THE INVENTION

While one might use a smaller dish, or multiple small portions in a larger dish, to slow the feeding rate of an animal, one would soon tire of filling and refilling the dish while the animal looked on in frustration.

The present invention provides a food dish with means for slowing the feeding rate of an animal while allowing a single filling of the receptacle area, or areas, of the dish. The means for limiting the feeding rate may generally be a body tenaciously attached to, or formed integrally with, and lying within the boundaries of the main receptacle area such that the animal cannot remove the body. In one embodiment, a post is centrally placed in the main receptacle area. The central post may serve other functions such as a handle extension, which handle may be made removable from the post. The post may additionally be made to be collapsible for ease of storage. The post may be removable from the main receptacle.

The means for limiting the feeding rate might alternatively be a substantially wedge-shaped body lying within the volume of the main receptacle. In some embodiments the means for limiting the feeding rate may be a two-tiered series of volumes spaced in the vertical direction within a common volume of the main receptacle. In other embodiments the means for limiting the feeding rate may be a series of separate volumes in the horizontal direction within the boundaries of the main receptacle. In still other embodiments the means for limiting may be a series of separate volumes in both of the horizontal direction and in the vertical direction within the boundaries of the of the main receptacle.

Desirably, the means for limiting the feeding rate is constructed and arranged such that no food particles are entrapped in inaccessible crannies within the dish such that a minimum of unnecessary frustration is encountered by the feeding animal while still slowing the tendency for ravenous feeding. The overall shape of the food dish may be such that it eliminates a source of frustration for the animal by having at least one flat side surface which will abut a wall to limit sliding motion of the food dish caused by the ravenous animal pushing against the food dish.

### BRIEF DESCRIPTION OF THE DRAWINGS

The aspects of this invention will be better understood from the following detailed description taken in conjunction with the drawings wherein:

FIG. 1 is a partial cross section elevation of the food dish showing the main receptacle cut away for clear viewing of the center post.

FIG. 2 is an elevation similar to FIG. 1, but illustrating a telescoping center post which can be collapsed to facilitate storage of the food dish and showing the head of a ravenous animal within the restricted feeding area.

FIGS. 3-5 are top views of alternative embodiments illustrating variously shaped main receptacles and center posts.

FIG. 6 is a cross section elevation of a food dish showing a multi-level segmentation of the main receptacle in the vertical direction.

FIG. 7 is a cross section elevation of a food dish showing a multi-level segmentation of the main receptacle in the vertical direction and further segmentation in the horizontal direction.

FIG. 8 is a top view of another food dish embodiment showing a segmentation of the main receptacle by division of the feeding area into smaller discrete chambers and volumes.

FIG. 9 is a top view of a rectangular food dish embodiment showing a restriction of the main receptacle by placement of a curved body therein.

### DETAILED DESCRIPTION OF THE PREFERRED EMBODIMENTS

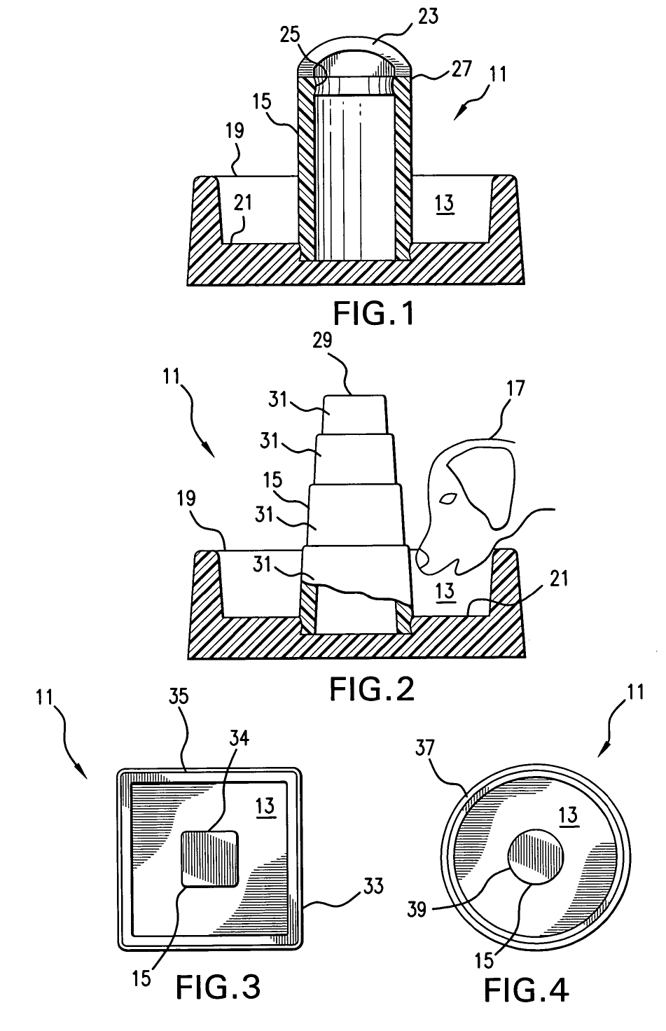

Referencing FIG. 1 and FIG. 2, a partial cross section elevation of the food dish 11 shows a main receptacle 13 cut away for clear viewing of the center post 15 which restricts access by an animal 17 to the entire feeding area of the receptacle 13. Particularly as seen in FIG. 2, showing the head of a ravenous animal 17 accessing the restricted feeding area through a top plane 19 of the receptacle 13, the animal 17 may be limited in the amount it can open its jaws, or the amount of food available within a given area of the receptacle 13, or both, thereby limiting the amount of food the animal 17 can continuously and uninterruptedly consume, thereby slowing the rate of consumption of food which may cause harm to the animal 17.

The center post 15 is shown as press fit into a recess below the bottom plane 21 of the receptacle 13 and, in FIG. 1, as having a removable handle 23 press fit into a recess 25 in the top of the post 15. The center post 15 may otherwise be attached by various tenacious but disengagable means such as thread and screw, interlocking channel and post, or the like, or may be integrally formed as a part of the dish 11. The post 15 may be hollow or solid and desirably has smooth walls and a close fit to the main receptacle 13 to discourage food entrapment therein which might frustrate the animal. The details of construction and attachment of the handle 23 may likewise be left to the sound discretion of the designer and need not be limited to the exemplary illustration.

As seen in FIG. 2, the post 15 may be a telescoping and collapsible center post 29 comprising interlocking sections collectively 31, of decreasing diameter as they extend upwardly from the receptacle 13, and which can be collapsed downwardly towards a bottom plane 21 of the receptacle 13 to facilitate storage of the food dish 11. While indicated in the sectional views as comprising a plastic material, it will be realized that the embodiments of the present invention may be formed from a variety of suitable materials.

FIGS. 3-5 are top views of alternative embodiments illustrating that the present invention may have variously shaped main receptacles 13 and center posts 15. FIG. 3 illustrates a square shape dish 33 and center post 34 which efficaciously provides at least one flat side surface 35 which can abut a wall or the like (not shown) to limit sliding motion of the food dish 33 caused by the ravenous animal pushing against the food dish, thereby eliminating a source of frustration for the animal during feeding. With more than one flat side surface 35 it will be appreciated that a sliding motion of a feeding dish 11 may be restricted in two horizontal axes. FIG. 4 illustrates a round feeding dish 37 and round center post 39. FIG. 5 shows an oval feeding dish 41 and oval center post 43. The post 15 described as being centered or centrally located within the main receptacle 13, can include posts which are not necessarily be concentric and which may be off center and still fulfill the intended function. Further, while the post 15 is illustrated as having a circumference shape matching the circumference shape of the main receptacle wall or walls, such an arrangement is not strictly necessary for the functioning of the invention.

Referring to FIG. 6, a cross section elevation of another embodiment 45 of a feeding dish 11 according to the present invention shows a multi-level segmentation of the main receptacle 13 in the vertical direction indicated by arrow 47 as formed by short posts, walls, or other bodies, 48 extending upwardly from the bottom plane 21 of the receptacle 13 to a fraction, illustrated as approximately one-half, of the vertical dimension of the main receptacle 13. A complementary boss or bosses 50 are formed on the dish side walls 52 to protrude into the main receptacle 13 at substantially the same height as the short walls 48. Thus, the short walls 48 and bosses 50 form an upper segment 49 of the main receptacle 13 which is open in the horizontal direction, indicated by arrow 51, while individual volumes, collectively 53, at a second or lower level 55 adjacent the bottom plane 21 of the receptacle 13, are formed into individual pockets, holes, or the like, and desirably may be formed as cylinders extending from the upper segment 49 toward the bottom plane 21. Thus, an animal will be forced to extricate food from the individual volumes 53 one at a time, thereby slowing its rate of consumption.

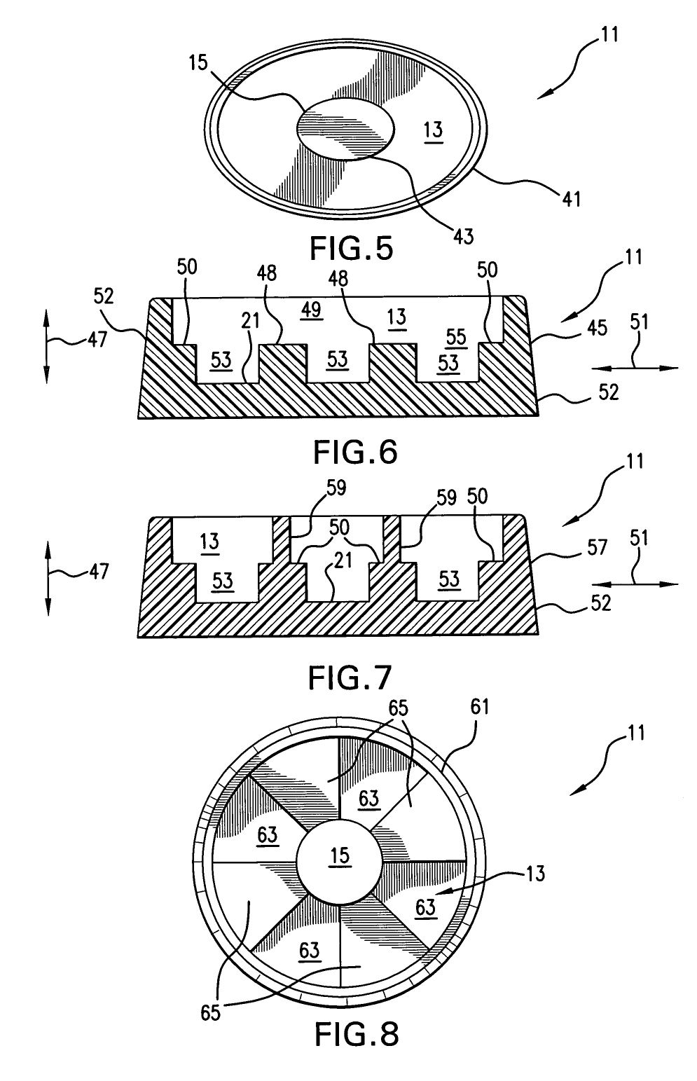

FIG. 7 is a cross section elevation of another embodiment 57 of a feeding dish 11 showing a multi-level segmentation of the main receptacle 13 in the vertical direction 47 and further segmentation in the horizontal direction 51. Similar in functional principles to the embodiment 45 of FIG. 6, the embodiment 57 of FIG. 7 will slow the feeding of the animal in two axes, vertical 47 and horizontal 51, by utilizing bodies 59 formed by posts, walls, or other bodies, extending upwardly from the bottom plane 21 of the receptacle 13 to the full vertical dimension of the main receptacle 13. A complementary boss or bosses 50 are formed on the bodies 59 and the dish side walls 52 to protrude into the main receptacle 13 at a substantial fraction of the vertical height of the receptacle thereby forming the lower level individual volumes 53. It will be appreciated that the apparatus and methodologies of the various embodiments of the present invention may be suitably combined if desired.

FIG. 8 is a top view of another embodiment 61 of a feeding dish 11 of the present invention showing a segmentation of the main receptacle 13 by division of the feeding area into smaller discrete chambers, collectively 63, and volumes through the placement of shaped bodies 65 therein. While shown as four truncated wedges arranged cruciform in the main receptacle 13 and abutting a central post 15, the shaped bodies 65 need not necessarily be either geometrically shaped or symmetrically arranged within the main receptacle 13.

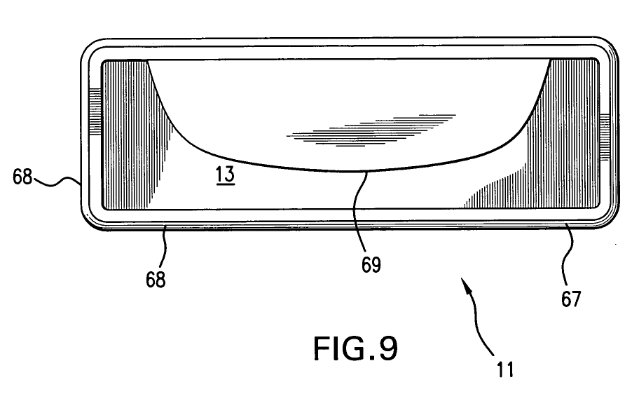

FIG. 9 is a top view of another embodiment of a feeding dish 11 of the present invention showing a rectangular food dish 67 with flat side surfaces, collectively 68. In this embodiment the main receptacle 13 has a restriction to slow the rate of eating caused by the placement of a body 69 having a curved, e.g., generally semi-elliptical, wall in the main receptacle 13, whereby the animal must follow a curved path in the course of its eating.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

We claim:

1. An animal feeding dish comprising:
a main receptacle having a volume for holding food; and
a body attached within or formed integrally within a volume of the main receptacle for limiting a feeding rate of the animal.

2. The animal feeding dish of claim 1 wherein the main receptacle has a top plane open to the environment for animal access and a closed bottom plane for retaining food.

3. The animal feeding dish of claim 1 wherein the body is a post located within the main receptacle.

4. The animal feeding dish of claim 1 wherein the post is centrally located within the main receptacle.

5. The animal feeding dish of claim 3 wherein the post is collapsible.

6. The animal feeding dish of claim 3 wherein the post has a handle.

7. The animal feeding dish of claim 6 wherein the handle is removable from the post.

8. The animal feeding dish of claim 3 wherein the post is removable from the main receptacle.

9. The animal feeding dish of claim 1 wherein the body is substantially wedge shaped.

10. The animal feeding dish of claim 1 wherein the body has a substantially curved shape.

11. The animal feeding dish of claim 1 wherein the body provides a segmentation of the main receptacle in a vertical direction.

12. The animal feeding dish of claim 1 wherein the body provides a segmentation of the main receptacle in a horizontal direction.

13. The animal feeding dish of claim 1 wherein the body provides a segmentation of the main receptacle in a horizontal direction and in a vertical direction.

14. The animal feeding dish of claim 1 further comprising at least one flat side surface.

15. The animal feeding dish of claim 1 wherein the body is tenaciously attached within or formed integrally within the volume.
